(19) United States
(12) Patent Application Publication
(10) Pub. No.: US 2025/0186293 A1
(43) Pub. Date: Jun. 12, 2025

(54) Massage Device

(71) Applicant: Dongguan Miss You Electronic Technology Co., Ltd., Dongguan (CN)

(72) Inventor: Wenbin ZHANG, Dongguan (CN)

(21) Appl. No.: 18/636,718

(22) Filed: Apr. 16, 2024

(30) Foreign Application Priority Data
May 19, 2023 (CN) 202321231402.3

(51) Int. Cl. A61H 9/00; A61H 7/00

(52) U.S. Cl. CPC A61H 9/0057; A61H 7/005; A61H 7/007; A61H 2201/1215; A61H 2201/1238; A61H 2201/1472; A61H 2201/1669

(57) ABSTRACT

A massage device having an end opening includes a housing, a massage chamber sleeve disposed in the housing, a massage chamber plug slidably fitted within the massage chamber sleeve, and a driving component including a drive shaft at least partially disposed in the massage chamber sleeve and functionally coupled with the massage chamber plug. The massage chamber sleeve defines a longitudinal axis and having an open end in air communication with the end opening of the massage device. The drive shaft is rotatable about the longitudinal axis, and the rotation of the drive shaft causes the massage chamber plug to move axially relative to the massage chamber sleeve.

### TECHNICAL FIELD

The present invention relates to the field of massage products, specifically relates to a health massage device.

### BACKGROUND

With the improvement of people's living standards, health massage has become part of people's daily lives. This has led to the rapid development of health massage products, and various types of massage products are now commonly seen in the market. The prevalent massage devices usually use a physical squeezing massage method, primarily involving a squeezing action of a massage head on the surface of the human skin.

For example, a health massager disclosed in Chinese Utility Model Publication No. CN208851961U includes a main body and a massage head. The main body and the massage head are integrally formed, with the main body containing a first PCB board and a first rechargeable battery, and the massage head contains a first driving component. A vibrating element is provided at the connection between the main body and the massage head, and inside the connection there is a connecting member. Driven by the vibrating element (which in turn is driven by the driving element), the massage head contacts and massages the surface of the human skin. However, for prolonged use, this kind of physical contact can cause user discomfort or even pain, negatively affecting the user experience.

### SUMMARY OF THE INVENTION

The present invention provides a health massage device that uses varying air pressure to massage the human body without relying on direct contact of physical component with the body. This can enhance the massage experience on the human body.

In one aspect of the present invention, a massage device is provided, which includes an opening at one end, and a housing including an air pressure massage section. The air pressure massage section includes a massage chamber sleeve defining a longitudinal axis. A driving component is included inside the housing and includes a drive shaft that is at least partially disposed inside the massage chamber sleeve. A massage chamber plug is fitted inside the massage chamber sleeve and can slide along the inner surface of the massage chamber sleeve. An open end of the massage chamber sleeve extends through the end opening of the massage device. The end opening of the massage device can be placed on a body surface of a human user. The drive shaft is effectively coupled with the massage chamber plug, and its rotation (driven by the motor) causes the massage chamber plug to move back and forth axially within the massage chamber sleeve.

In some embodiments, the massage chamber plug includes a closed end and a side tube wall extending from the closed end, and the drive shaft is circumferentially disposed inside the side tube wall of the massage chamber plug. The drive shaft is driven a drive motor to rotate about the longitudinal axis, and the rotation of the drive shaft causes the massage chamber plug to move axially relative to the massage chamber sleeve along the longitudinal axis.

In some embodiments, an outer circumferential surface of the drive shaft includes an obliquely looped groove, and the massage device also includes a sliding body coupled with the groove. The sliding body can be at least partially fitted and slidable within the groove, and is also connected with a sliding block that is connected with a portion of the side tube wall of the massage chamber plug. The rotation of the drive shaft causes the sliding body to slide in the groove, causing reciprocal axial movement of the sliding block along the longitudinal axis, which in turn causes synchronous reciprocal axial movement of the massage chamber plug relative to the massage chamber sleeve.

The obliquely looped groove can have a semi-circular cross-section. The sliding body can be a sphere, with one side of the sphere fitted within the groove on the drive shaft, and another opposing side of the sphere coupled to one side of the sliding block.

In some embodiments, the massage device further includes at least one rubber sealing ring disposed between an outer circumferential surface of the side tube wall of the massage chamber plug and an inner surface of the massage chamber sleeve.

The massage device can include a battery and a switch assembly disposed in the housing. The battery, switch assembly, and driving motor can be electrically connected. The switch assembly can have buttons partially embedded in the housing and extending outside the housing to allow user interaction.

In some embodiments, the housing includes an upper part and a lower part that are fitted together. The massage device can further include a base fitted at the bottom of the lower part of the housing. An outer protective sheath, e.g., an elastic sheath, can be sleeved on an outer surface of the housing.

In some embodiments, the housing can be provided with a charging port, and the charging port is electrically connected to the battery.

In some embodiments, the massage chamber sleeve can be sleeved with a soft tube fitted in the housing.

In some embodiments, the housing is made of plastic material.

The massage device of the present invention can achieve the following effects: The massage device utilizes a driving component to drive a massage chamber plug to move back and forth within the massage chamber sleeve. The end of the massage chamber sleeve and the surface of the human body form a sealed space. The movement of the massage chamber plug causes a change in air pressure within the sealed space, resulting in a force being applied to the muscle tissue of the human body, achieving massage effects such as grasping, kneading, and suction.

### BRIEF DESCRIPTION OF THE DRAWINGS

FIG. 1 is an exploded schematic view of a massage device of the present invention.

FIG. 2 is a schematic cross-sectional diagram of a massage device of the present invention.

FIG. 3 is an enlarged schematic cross-sectional diagram of part A shown in FIG. 2.

FIG. 4 is an enlarged perspective view of the drive shaft of a massage device of the present invention.

### REFERENCE NUMERALS IN THE DRAWINGS

1. Protective sheath
2. Housing upper part
3. Base of housing
4. Switch assembly
5. Massage chamber sleeve
6. Drive motor
7. Soft tube
8. Housing lower part
9. Battery
10. Motor fixing seat
11. Drive shaft
12. Massage chamber plug
13. Sliding body
14. Sliding block
15. Rubber sealing ring
51: Inner surface of massage chamber sleeve
61: Reduction gear
111: Obliquely looped groove
111a: upper end of obliquely looped groove
111b: Lower end of obliquely looped groove
121: Top closed end of massage chamber plug
122: Side tube wall of massage chamber plug
201. Upper opening of housing

### DETAILED DESCRIPTION

In the following, the embodiments of the present invention will be explained with reference to the drawings. Elements and features described in one embodiment or figure of the present invention may be combined with one or more elements and features shown in other figures or embodiments. It should be noted that, for clarity, representations and descriptions of components or processes known to those skilled in the art that are unrelated to the present invention have been omitted from the drawings and the description.

The figures herein are schematic representations and the configuration of the various elements of the disclosed invention as well as their relative dimensions are intended to be illustrative only. When terms such as “upper” and “lower”, “up” and “down”, “above” and “below”, “top” and “bottom”, “right” and “left”, or similar relative expressions are used, these only refer to the arrangement of elements or structures in the accompanying figures and not necessarily to an actual situation of use. It is obvious that “down” can become “up” if an object is flipped or simply viewed from a different perspective.

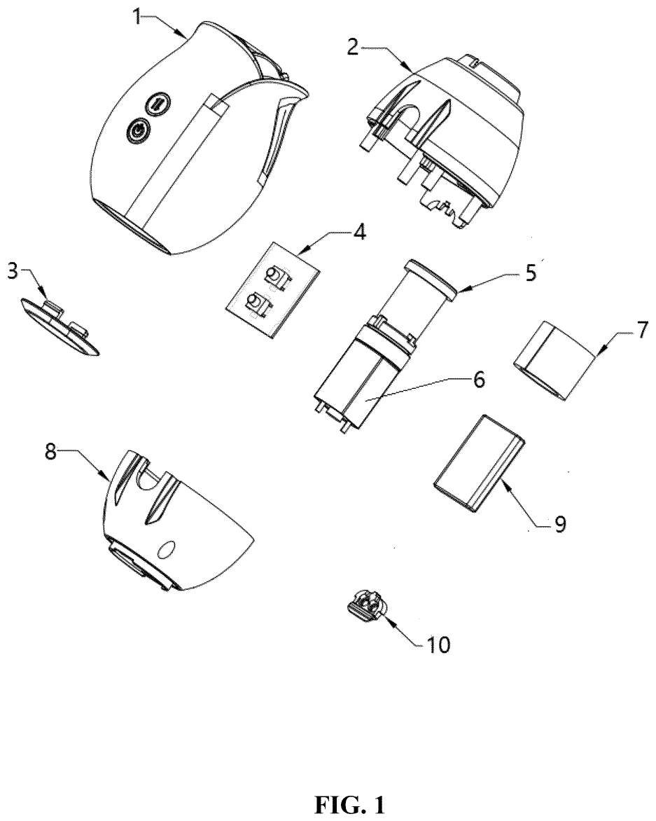

Referring to FIGS. 1-4, the present invention provides a health massage device comprising a housing including an upper part 2 and a lower part 8, where the upper part 2 and the lower part 8 can be connected and fitted to each other. A base 3 is disposed at the bottom of the housing lower part 8. An upper end opening 201 of the massage device is located at the upper end of the housing upper part 2 and formed by a protective sheath 1 (which is further described below). The interior of the housing below the end opening 201 comprises an air pressure massage section that includes a massage chamber sleeve 5 which takes an open cylindrical tube configuration. The massage chamber sleeve 5 defines a longitudinal axis X1, which axis also coincides with the rotation axis of the drive shaft 11 as will be further described below.

Disposed inside the massage chamber sleeve 5 is a massage chamber plug 12 that includes a top closed end 121, and a side tube wall 122 extending axially from the top closed end 121 and away from the top end 5a of the massage chamber sleeve 5. The top end 5a of the massage chamber sleeve 5 abuts against the lower end of the opening 201 and is sealedly connected to the end opening 201. Thus, the open top end 5a of the massage chamber sleeve 5 is in fluid (or air) communication with the end opening 201 of the massage device. The bottom of the massage chamber plug 12 is open ended, and accommodate at least a portion of a drive shaft 11 as further described below.

A driving component includes a drive motor 6, and an output end of the drive motor 6 is connected to a drive shaft 11 via a reduction gear 61. The drive shaft 11 can have a generally cylindrical shape having a cylindrical axis coinciding with the longitudinal axis X1 about which it is rotatable as driven by the drive motor 6. The drive shaft 11 is disposed inside and circumferentially surrounded by the side tube wall 122 of the massage chamber plug 12.

To reduce the impact of the axial movement of the massage chamber plug 12 on the drive shaft 11, a protrusion 11a is provided at the top of the drive shaft 11 for stabilization.

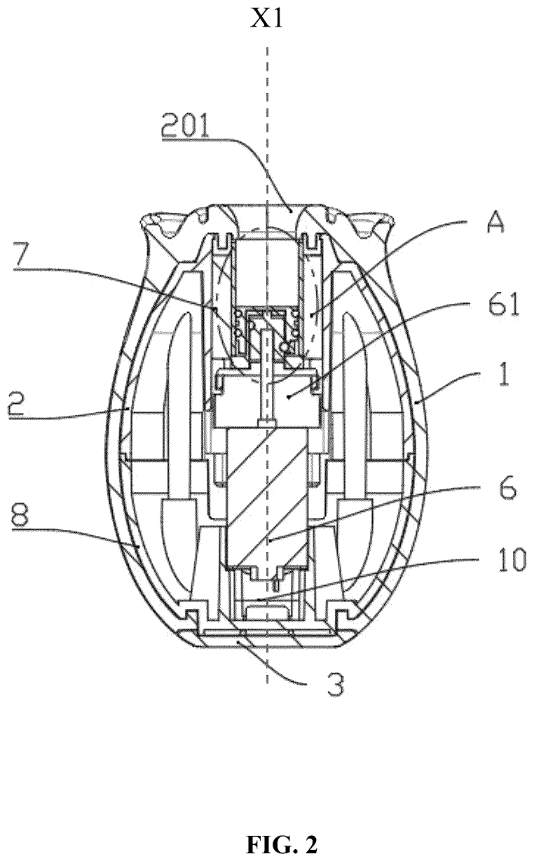

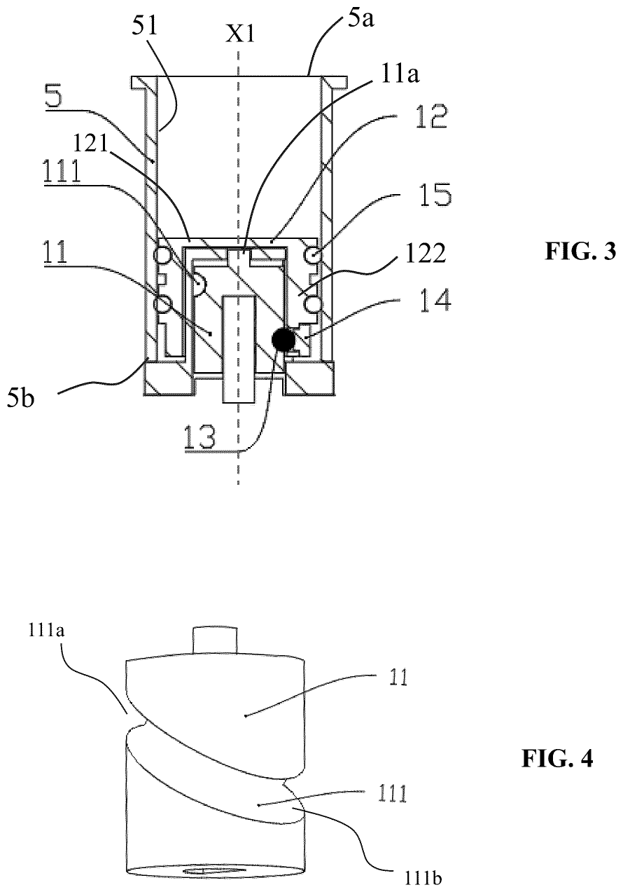

The outer cylindrical surface of the drive shaft 11 includes an obliquely arranged groove 111 as shown in FIGS. 2-4. The groove forms a closed loop around the outer cylindrical surface of the drive shaft 11 and its length direction forms an angle relative to the longitudinal axis X1. The upper end 111a of the groove is closer to the closed end 121 of the massage chamber plug 12 than the lower end 111b of the groove. As shown, the lower end 111b of the groove 111 is above the lower end 5b of massage chamber sleeve 5, and the entire side tube wall 122 of the massage chamber plug 12 on its length (or axial) direction is enclosed within the massage chamber sleeve 5. A part of the sliding body 13 (left part as shown in FIG. 3) is slidably fitted in the groove 111, and another part of the sliding body 13 (right part as shown in FIG. 3) is connected or attached to a sliding block 14. The sliding block 14 is fixedly connected with (e.g., embedded within or attached to) a portion of the massage chamber plug side tube wall 122. As shown, the sliding block 14 can be disposed at the bottom of the side tube wall 122 on one side and can move up and down with the chamber massage side tube wall 122. The sliding block 14 can also be considered as an integral part of the side tube wall 122.

In some embodiments, as shown in FIGS. 3-4, the groove 111 on the drive shaft 11 can have a semicircular cross-section. The sliding body 13 can be a sphere, with half of it fitted in the groove, and the other half connected with one side of the sliding block 14. The sliding body 13 and the sliding block 14 can also be formed integrally as a unified slider structure with part of the slider structure slidably engaging the groove and another part of the slider structure fixedly connected with the side tube wall 122 of the chamber massage plug 12.

When the drive shaft 11 rotates about the longitudinal axis X1, the sliding body 13 moves along the groove 111, driving the sliding block 14 to move axially along the longitudinal axis X1 (i.e., up and down as shown), which in turn causes the massage chamber plug side tube wall 122 (and the entire massage chamber plug 12) to move axially along the longitudinal axis X1 in the massage chamber sleeve 5.

For good sealing between the massage chamber sleeve 5 and the massage chamber plug 12, rubber sealing rings 15 can be sleeved on the outer circumferential surface of the side tube wall 122 of the massage chamber plug 12 and contacting the inner surface 51 of the massage chamber sleeve 5. When there are double sealing rings as shown in FIG. 3, the rubber sealing rings can be spaced along the length of the side tube wall 122 of the massage chamber plug 12.

The drive motor 6 can be powered by an internal or external power source, which can be a battery 9 (either a disposable battery or a rechargeable battery). The housing can include the battery and a switch assembly 4. The battery 9, switch assembly 4, and drive motor 6 can be electrically connected.

To maintain the stability of the device, the rechargeable battery can be installed on a battery holder on the inner side of the housing. The switch assembly 4 can include a PCB circuit board and buttons, where the PCB circuit board is fixed inside the housing, and the buttons can be partially embedded on the housing wall and electrically connected to the PCB circuit board.

For easy charging of the rechargeable battery, a charging port can be provided in the housing, e.g., embedded in the housing, and the charging port is electrically connected to the rechargeable battery through the switch assembly. The rechargeable battery is preferably a polymer battery.

In order to provide stability for the components of the massage device, the bottom of the drive motor 6 can be set on a motor fixing seat 10 inside the housing, and the motor fixing seat 10 can be set on the base 3. Also, for noise reduction, a soft tube 7, such as EVA foam, can be sleeved on the outer circumferential surface of the massage chamber sleeve 5.

The speed of the drive motor 6 can be adjustable, and different massage effects and personalized usage requirements can also be achieved by controlling the buttons.

Further, to improve user experience, a layer of protective sheath 1 is provided to wrap around the outside of the housing. The shape of the sheath 1 can conform to the shape of the housing. Ergonomical design can be used to for user comfort in grasping or holding the massage device. In the drawings, the housing takes an overall unopened rose-shaped structure. Of course, an eggshell-shaped structure suitable for holding can also be used. The protective sheath 1 can be made of an elastic material, such as modified plastic, rubber, or silicone, including materials like silicone and EVA. Silicone is preferred due to its good flexibility, elasticity, and skin-friendly properties. It has high mechanical strength, is wear-resistant, and suitable for contact with the human body.

For ease of assembly of internal components, mounting columns can be included on the bottom of the housing upper part 2, and slots matching the mounting columns can be included on the housing lower part 8. The mounting columns are inserted into the corresponding slots to achieve connection between the housing upper part 2 and the housing lower part 8.

To better control the massage effect when the protective sheath 1 is gripped by the hand, elastic keys integrated with the protective sheath 1 can be provided. The inner surface of the elastic keys can be fitted against buttons of the switch assembly, and pressing the elastic keys controls the corresponding buttons.

In the use of the massage device, a user can place the end opening 201 of the massage device tightly against a body or skin surface of the user to seal a volume of air in the space enclosed by the top closed end 121 of the massage chamber plug 12, the massage chamber sleeve 5, and the body surface. When the user powers on and activates the motor, the motor drives the drive shaft 11 to rotate along the longitudinal axis X1, which drives the sliding body 13 to move along the groove 111. This movement of the sliding body 13 generates a reciprocal axial movement of the sliding block 14 along the longitudinal axis X1, the axial stroke of which corresponds to the axial distance between the upper end 111a of the groove and the lower end 111b of the groove 111. Each complete 360 degree turn of the drive shaft produces an upward move and a downward move of the sliding block 14, i.e., one full linear reciprocal stroke. As the side tube wall 122 of the massage chamber plug 12 is fixedly connected to the sliding block 14, the massage chamber plug 12 will slide reciprocally axially against the inner surface of the massage chamber sleeve 5 in sync with the axial movement of the sliding block 14, thereby generating a varying air pressure in the space enclosed by the top closed end 121 of the massage chamber plug 12, the massage chamber sleeve 5 (the portion above the top closed end 121 of the massage chamber plug 12), and the body surface of the user. This varying air pressure is applied to the body surface of the user, creating a massage effect (e.g., stimulation or relaxation).

Although the present invention and its advantages have been described in detail, various changes, substitutions, and alterations can be made without departing from the spirit and scope defined by the appended claims. Moreover, the scope of the present application is not limited to the specific embodiments of devices, structures, means, methods, or steps described in this specification. Those skilled in the art will understand, based on the disclosure in the present invention, that existing and future devices, structures, means, methods, or steps that perform functions substantially similar to those described in the corresponding embodiments can be used or achieved. Therefore, the appended claims are intended to include such devices, structures, means, methods, or steps within their scope.

1. A massage device having an end opening, comprising:
a housing;
a massage chamber sleeve disposed in the housing, the massage chamber sleeve defining a longitudinal axis and having an open end in air communication with the end opening of the massage device and;
a massage chamber plug slidably fitted within the massage chamber sleeve; and
a driving component including a drive shaft at least partially disposed in the massage chamber sleeve, the drive shaft being rotatable about the longitudinal axis, wherein the rotation of the drive shaft about the longitudinal axis causes the massage chamber plug to move axially along the longitudinal axis relative to the massage chamber sleeve.

2. The massage device according claim 1, further comprising a sliding block fixedly connected with the massage chamber plug, wherein the drive shaft is coupled on its outer circumferential surface with the sliding block, and wherein the rotation of the drive shaft about the longitudinal axis causes the sliding block to move axially along the longitudinal axis which in turn causes the massage chamber plug to move axially along the longitudinal axis.

3. The massage device according to claim 2, wherein the massage chamber plug includes a closed end and a side tube wall extending therefrom and away from the open end of the massage chamber sleeve, and wherein the drive shaft is circumferentially disposed inside the side tube wall of the massage chamber plug, and wherein the sliding block is fixedly connected with a portion of the side tube wall of the massage chamber plug.

4. The massage device according to claim 3, further including a sliding body connected with the sliding block, wherein an outer circumferential surface of the drive shaft includes an obliquely looped groove, the sliding body at least partially being fitted and slidable within the obliquely looped groove.

5. The massage device according to claim 4, wherein the obliquely looped groove has a semi-circular cross-section, and the sliding body including a sphere, with a portion of the sphere fitted within the obliquely looped groove and an opposing portion of the sphere connected to the sliding block.

6. The massage device according to claim 3, further comprising at least one rubber sealing ring disposed between the side tube wall of the massage chamber plug and an inner surface of the massage chamber sleeve.

7. The massage device according to claim 1, further comprising a soft tube wrapping on an outer side of the massage chamber sleeve.

8. The massage device according to claim 1, further comprising:
a battery, and a switch assembly electrically connected with both the battery and the driving component.
